(19) United States
(12) Patent Application Publication
(10) Pub. No.: US 2024/0067497 A1
(43) Pub. Date: Feb. 29, 2024

(54) SAFETY SYSTEM FOR AN ELEVATOR

(71) Applicant: Otis Elevator Company, Farmington, CT (US)

(72) Inventors: Javier Muñoz Sotoca, Rivas-Vaciamadrid (ES); Luis Mena Rosell, Getafe (ES)

(21) Appl. No.: 17/987,522

(22) Filed: Nov. 15, 2022

(30) Foreign Application Priority Data
Aug. 25, 2022 (EP) 22382799.9

(51) Int. Cl. B66B 5/00; B66B 3/00

(52) U.S. Cl. CPC B66B 5/0081; B66B 3/002; B66B 5/0062; B66B 1/3461

(57) ABSTRACT

An elevator safety includes a barrier (108) for installation on an external upper surface (106) of an elevator car (102) and a sensor. The sensor is configured to detect a change in the barrier (108) and the system is configured to produce a safety signal when a change in the barrier (108) is detected by the sensor. The sensor may be configured to detect a movement of at least part (316; 426; 548) of the barrier (108). The sensor may be configured to detect a change in the load applied to at least part (626; 726) of the barrier (108). The sensor may be configured to detect a change in resistance in at least part of the barrier (108).

### FOREIGN PRIORITY

This application claims priority to European Patent Application No. 22382799.9, filed Aug. 25, 2022, and all the benefits accruing therefrom under 35 U.S.C. § 119, the contents of which in its entirety are herein incorporated by reference.

### TECHNICAL FIELD

This disclosure relates to a safety system for an elevator. In particular, the disclosure may be applicable to barriers such as safety barriers for elevator refuge spaces that can be accessed by people, for example maintenance workers.

### BACKGROUND

Maintenance procedures for elevator systems often involve maintenance personnel accessing the hoistway of the elevator system and carrying out maintenance procedures from the top of the elevator car.

Accidents and injury to maintenance personnel have been known to occur during such maintenance procedures. For example, the maintenance personnel may be positioned on top of the elevator car, and may extend a body part, for example their arm, beyond the elevator car perimeter whilst the elevator car is moving, which may result in the body part becoming caught in the hoistway. A safety barrier may be provided on top of elevator cars to stop maintenance personnel from falling from the car or extending body parts beyond the elevator car perimeter. However, when maintenance personnel lean against the safety barrier, the barrier may deform or fail.

The present disclosure seeks to address at least some of the drawbacks described above.

### SUMMARY

According to a first aspect of this disclosure there is provided an elevator safety system comprising: a barrier for installation on an external upper surface of an elevator car; and a sensor, wherein the sensor is configured to detect a change in the barrier, wherein the system is configured to produce a safety signal when a change in the barrier is detected by the sensor.

This system enables the detection of a change in a barrier on an external upper surface of an elevator car and the production of a safety signal when a change is detected. This enables improved safety for maintenance personnel.

The barrier can be any suitable barrier, including but not limited to a barrier which extends along one, two, three or all four sides of the elevator car. Further, the barrier may be of solid type construction or may comprise one or more rails fixed to support members. Further, the barrier may be permanently fixed in place or alternatively, may be a retractable or telescopic barrier configured to be moved into position by maintenance personnel when required.

The safety signal can be any signal that is suitable for communicating information. For example, the safety signal could be a binary signal (i.e. simply indicating that a change in the barrier has occurred). In some examples, the safety signal can include more information, for example the location of the elevator system. The safety signal can be sent in any conventional manner, for example a signal sent over a wireless internet connection, Bluetooth, or as an electrical signal.

The sensor may be configured to detect any change in the barrier including any change which may indicate a potential failure in the barrier. Such a change may include but is not limited to one or more of: a change in position (or a movement) of at least part of the barrier; a change in a force applied to at least part of the barrier; and/or a change in the electrical properties of at least part of the barrier.

In some examples, the sensor may be configured to detect a movement of at least part of the barrier. In some examples, the sensor may be configured to detect a movement of a part of the barrier which is spaced from the external upper surface of the elevator car. The barrier may be fixed to the external upper surface of the elevator car such that the part of the barrier that is fixed does not move relative to the elevator car. When for example, a maintenance person leans against the barrier, the part of the barrier which is spaced from the external upper surface of the elevator car may however bend or deform under their weight and so may move relative to the elevator car such that this movement may be detected.

The sensor may take many different forms. In some examples, the sensor may comprise a light beam emitter and a light beam receiver. The sensor may be configured such that light emitted from the light beam emitter is not received by the light beam receiver when the at least part of the barrier is in a first position but is received by the light beam receiver when the at least part of the barrier has moved to a second position, and the safety signal may be produced when the light is received by the light beam receiver.

In these examples, any combination of the position of the light beam emitter, the position of the light beam receiver and the angle at which the light beam is emitted may be varied. These examples therefore provide an accurate means of detecting when the at least part of the barrier has moved by a desired amount and also allow for adjusting the sensor to detect a different amount of movement of the at least part of the barrier if required.

In other examples, the sensor may comprise a switch configured to switch from a first state to a second state when the at least part of the barrier has moved from a first position to a second position. The at least part of the barrier may be movable relative to another part of the barrier, and the switch may be mounted to the other part of the barrier and may be configured to switch from the first state to the second state when the at least part of the barrier is moved into contact with the switch.

The at least part of the barrier may be resiliently biased away from the other part of the barrier.

In other examples, the sensor may be configured to detect a change in the load applied to at least part of the barrier.

For example, the sensor may comprise a load cell mounted to the at least part of the barrier or the sensor may comprise a piezoelectric sensor mounted to the at least part of the barrier.

In other examples, the sensor may be configured to detect a change in resistance in at least part of the barrier.

In any example of the disclosure, the at least part of the barrier may comprise a rail configured to be spaced from the external upper surface of the elevator car when installed thereon.

From a further aspect, the present disclosure provides an elevator system comprising: a hoistway; an elevator car; and an elevator safety system as in any described example thereof.

The elevator system can be any elevator system known in the art. The elevator can be hoisted using any mechanism, for example ropes, chains, or hydraulics. The elevator system can include any number of elevator cars and any number of elevator hoistways. The elevator can be configured to carry goods of any weight and/or size, and may comprise for example a passenger, service or freight elevator.

In any example of the disclosure, the elevator system may further comprise an elevator controller, configured to receive the safety signal from the sensor. The elevator controller may be configured to implement a safety response upon receiving the safety signal from the sensor. Thus, a safety response may be implemented automatically by the elevator controller when a safety signal is received, allowing for a very quick safety response from the elevator without the need, for example, for human intervention.

In some examples, the safety response may comprise an emergency stop.

In some examples, the safety response may comprise moving the elevator car at a reduced speed.

In some examples, the safety response may comprise sending a signal to a communications centre or a building manager.

In some examples, the safety response may comprise operating an alarm.

In some examples, the elevator system may further comprise a safety chain configured to receive the safety signal from the sensor. Upon receiving the safety signal from the sensor, the safety chain may be broken.

From a further aspect of the disclosure, a method of operating an elevator safety system is provided, the method comprising: detecting, by at least one sensor, a change in a barrier of the elevator safety system; and producing, from the at least one sensor, a safety signal indicating the change.

In some examples, the detecting, by at least one sensor, a change in a barrier of the elevator safety system may comprise detecting, by at least one sensor, a movement of at least part of the barrier. In some examples, the detecting, by at least one sensor, a movement of at least part of the barrier may comprise detecting, by at least one sensor, a movement of a part of the barrier which is spaced from the external upper surface of the elevator car. The barrier may be fixed to the external upper surface of the elevator car such that the part of the barrier that is fixed does not move relative to the elevator car. When for example, a maintenance person leans against the barrier, the part of the barrier which is spaced from the external upper surface of the elevator car may however bend or deform under their weight and so may move relative to the elevator car such that this movement may be detected.

In other examples, the detecting, by at least one sensor, a change in a barrier of the elevator safety system may comprise detecting, by at least one sensor, a change in the load applied to at least part of the barrier.

In other examples, the detecting, by at least one sensor, a change in a barrier of the elevator safety system may comprise detecting, by at least one sensor, a change in resistance in at least part of the barrier.

In any example of the disclosure, the method may further comprise an elevator controller receiving the safety signal from the sensor. The method may still further comprise the elevator controller implementing a safety response upon receiving the safety signal from the sensor. Thus, a safety response may be implemented automatically by the elevator controller when a safety signal is received, allowing for a very quick safety response from the elevator without the need, for example, for human intervention.

In some examples, the safety response may comprise an emergency stop.

In some examples, the safety response may comprise moving the elevator car at a reduced speed.

In some examples, the safety response may comprise sending a signal to a communications centre or a building manager.

In some examples, the safety response may comprise operating an alarm.

In some examples, the method may further comprise a safety chain receiving the safety signal from the sensor. Upon receiving the safety signal from the sensor, the safety chain may be broken.

### DRAWING DESCRIPTION

Some examples of this disclosure will now be described, by way of example only, with reference to the accompanying drawings, in which:

FIG. 1 is a schematic illustration of an elevator system;

FIG. 2 is a schematic perspective view of part of an elevator car and a safety barrier;

FIGS. 3A and 3B are schematic side views of a safety system according to one example of the disclosure;

FIGS. 4A and 4B are schematic side views of a safety system according to another example of the disclosure;

FIG. 5 is a schematic cross section view of a safety system according to another example of the disclosure;

FIG. 6 is a schematic cross section view of a safety system according to another example of the disclosure;

FIG. 7 is a schematic cross section view of a safety system according to another example of the disclosure;

FIG. 8 is a schematic perspective view of part of an elevator car and a safety system according to another example of the disclosure; and

FIGS. 9 and 10 are flow charts showing methods of detecting changes in a barrier and generating a safety signal in accordance with examples of the present disclosure.

### DETAILED DESCRIPTION

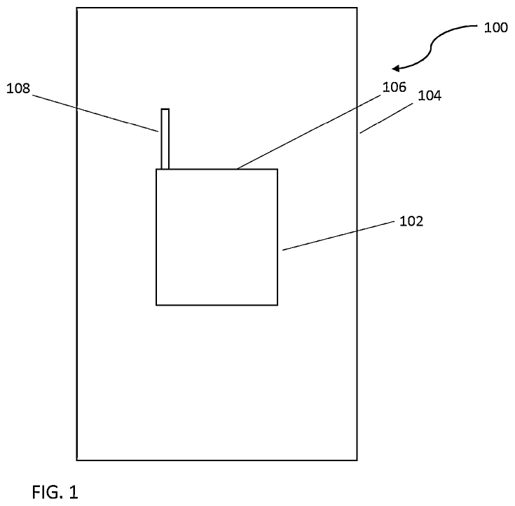

FIG. 1 shows an elevator system 100 including an elevator car 102 configured to move up and down within a hoistway 104. Various components of the elevator system 100 have been omitted for clarity, but it will be appreciated that the elevator system 100 may include other standard components including but not limited to a drive means, a tension member, a counterweight, a controller and a plurality of elevator landing doors.

During a maintenance procedure, maintenance personnel (not shown in FIG. 1) may perform maintenance operations while standing on an external upper surface 106 of the elevator car 102. From here, the maintenance personnel may perform maintenance procedures on top of the elevator car 102, or at desired locations in the hoistway 104 by reaching beyond the elevator car 102.

To help protect the maintenance personnel from injury, the elevator car 102 may include a barrier 108 extending from the external upper surface 106 of the elevator car 102.

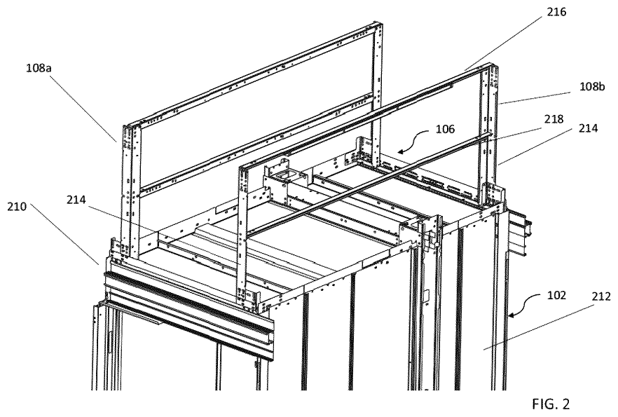

FIG. 2 shows a schematic perspective view of part of an elevator car 102. In any example of the disclosure, the elevator car 102 has an external upper surface 106 which is accessible by maintenance personnel. In at least some examples, the external upper surface 106 may be formed by the roof of the elevator car 102. An elevator safety system according to any example of the disclosure may be installed on the elevator car 102. The elevator safety system comprises a barrier 108 for installation on the external upper surface 106 of the elevator car 102 and a sensor (not shown in FIG. 2). The sensor is configured to detect a change in the barrier 108, and the system is configured to produce a safety signal when a change in the barrier 108 is detected by the sensor.

The barrier 108 may take any desired form and may for example be a permanent barrier, a removable barrier, a retractable barrier or a telescopic barrier. Further, the barrier could be formed as a solid sheet or in any other desired configuration.

In the example shown in FIG. 2, a first barrier 108a is provided on a first side 210 of the elevator car 102 and a second barrier 108b is provided on a second, opposite side 212 of the elevator car 102. It will be understood that in other examples of the disclosure (not shown) only a single barrier may be provided and extend across at least part of one side of the elevator car. In other examples which are also not shown, a single barrier may extend across at least part of two, three or four sides of the elevator car. In still further examples, one or more separate barriers may be provided at one, two, three or all four sides of the elevator car.

In the example of FIG. 2, each barrier 108a, 108b includes first and second support members 214 which are spaced apart from each other and are configured to be attached to the external upper surface 106 of the elevator car 102. A rail 216 extends between the support members 214 so as to extend along a side of the elevator car 102 and be spaced from the external upper surface 106 thereof when installed. In some examples and as shown in FIG. 2, an intermediate rail 218 may also be provided which extends between the support members 214 and is spaced from the rail 216 so as to be located between the external upper surface 106 and the rail 216. It will be understood that in any example of the disclosure, any desired number of intermediate rails may be provided. It will further be understood that in any example of the disclosure, any desired number of support members may be provided. The intermediate rail(s) and the support members may have the function of reducing the chance of a person falling from the external upper surface 106.

In the example shown in FIG. 2, the safety barriers 108a, 108b are fixed to the elevator car 102 and are configured to remain in position during use of the elevator car 102. The support members 214 extend in an approximately vertical direction, in other words they extend approximately perpendicular to the external upper surface 106. It will be understood however that if desired, the support members could extend at a different angle to the external upper surface 106, for example extending outwardly and inwardly towards the centre of the external upper surface 106.

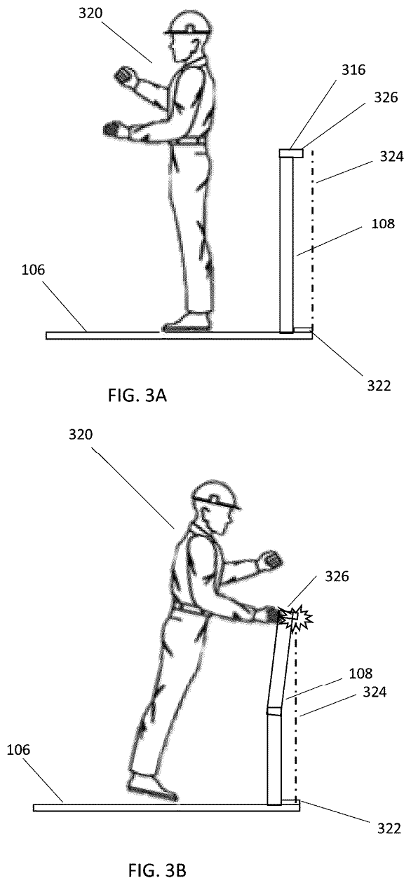

FIGS. 3A and 3B are schematic illustrations of an elevator safety system according to a first example of the disclosure when installed on an elevator car (not shown). In some examples such as the example shown, the sensor may be a sensor for sensing movement of the barrier or a deflection in the barrier 108. The figures show a schematic side view of a barrier 108, mounted to the external upper surface 106 of an elevator car. As seen, a person 320 may stand on the external upper surface 106 when required to carry out maintenance on the elevator system. The sensor of the example shown comprises a light beam emitter and receiver. A beam emitter 322 is mounted to the external upper surface 106 of the elevator car 102. The beam emitter 322 is configured to emit a beam such as for example, a laser beam 324. A receiver 326 is also provided and is mounted to the barrier 108 at a location spaced from the external upper surface 106. In the example shown, the receiver 326 may be mounted to a rail 316 forming an upper end of the barrier 108. When the barrier 108 is in its installed position ready for use, the support members thereof may extend in an approximately vertical direction. However, if a person 320 leans against the barrier 108, for example leaning on the rail 316, they may cause the barrier 108 to move or bend. This might be the case if the person leans excessively on the barrier while reaching for something for example. It will be understood that deformation of the barrier 108 should not exceed a predetermined amount to avoid the possibility of placing maintenance personnel in danger. In one example from the industry, the standard EN81-20 requires a barrier above an elevator car to deform by less than 50 mm when subjected to a horizontal force of 1000 N. However, if a person stretches over the barrier or if their weight is high, it may be possible to exceed the maximum loading of 1000 N and, in such cases, the system according to the disclosure may avert a potentially dangerous situation by detecting that the barrier 108 has been deformed by more than a maximum allowable amount.

The beam emitter 322 may be configured to emit a beam 324 in a direction substantially parallel to the support members. The beam 324 may be spaced from the support members. The beam 324 may be positioned externally of the barrier 108. When the barrier 108 is in its normal position therefore, the beam 324 may extend vertically and so will not be detected by the receiver 326. This position is shown in FIG. 3A.

However, as the barrier 108 is caused to bend outwardly (away from the centre of the external upper surface 106), the receiver 326 will move towards the beam 324. The emitter 322 and the receiver 326 may be positioned such that the beam 324 will be detected by the receiver 326 when the barrier 108 has bent by a threshold amount corresponding, for example, to the maximum safe loading on the safety barrier 108. This position is shown in FIG. 3B. In other examples, the maximum desired movement of the barrier may be in a range of about 10 mm to 25 mm, for example, about 15 mm. In some other examples as described above, EN81-20 states that the maximum allowable deflection of a safety barrier when subjected to a force of 1000 N is 50 mm and so the maximum desired movement of the barrier may be 50 mm or less.

In another example (not shown) a reflector may be provided in place of the receiver of FIGS. 3A and 3B and the emitter may also comprise a receiver for detecting a beam which is reflected back to it from the reflector. In this example, the system will operate in a manner very similar to that of the example of FIGS. 3A and 3B. However, the beam will be reflected back to the emitter by the reflector and then detected at the emitter when the barrier has bent by a threshold amount.

In another example (also not shown) the emitter may also comprise a receiver for detecting a beam which is reflected back to it by a part of the barrier. In this example, the system will operate in a manner very similar to that of the example of FIGS. 3A and 3B. However, the beam will be reflected back to the emitter by the barrier itself and then detected at the emitter when the barrier has bent by a threshold amount.

In further examples of the disclosure, it will be understood that the emitter could be configured to emit a beam at any suitable angle, which might not be vertical or parallel to the support members. In such examples, the receiver and/or the reflector could be mounted in any desired location on the elevator car or on the barrier to allow movement of the barrier beyond a threshold amount to be detected.

In any example of the disclosure, the system may be configured to produce a safety signal when a change in the barrier is detected by the sensor. The safety signal may then be used to control operation of the elevator system, for example initiating an emergency stop of the elevator car or activating an alarm to show that personnel may be in danger as will be described in further detail below. In the examples described above with reference to FIGS. 3A and 3B, the safety signal may be produced when the beam is detected.

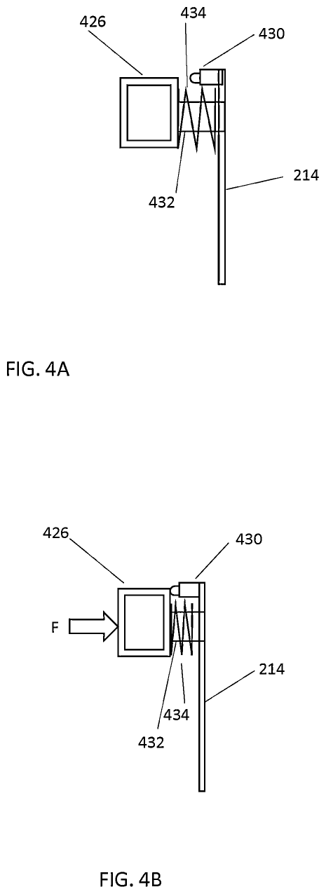

FIGS. 4A and 4B are schematic illustrations of an elevator safety system according to a further example of the disclosure. In these figures, the elevator car to which the barrier 108 may be mounted is not shown. In this example, the sensor may include a sensor, for example a switch, for detecting when a maximum allowable load on the barrier 108 is exceeded. As seen in FIG. 4A, a switch 430 is mounted to a support member 214 of the barrier 108 and is positioned adjacent to a rail 426 of the safety barrier.

The rail 426 is mounted to the support member 214 so as to be movable relative thereto in a direction perpendicular or generally perpendicular to the rail 426. In the example shown, the rail 426 is mounted to the support member 214 on a guide 432 so as to be spaced from the support member 214. A resilient means such as a compression spring 434 extends between the support member 214 and the rail 426 and acts to bias the rail 426 away from the support member 214 when no force is exerted on the rail 426. Thus, when no force is exerted on the rail 426, for example when there is no one leaning against it, the rail 426 will not activate the switch 430 and the switch will be in a first position.

As shown in FIG. 4B, when a horizontal force F of a predetermined magnitude or greater is applied to the rail 426, the rail 426 will compress the spring 434 such that the rail 426 activates the switch 430, moving the switch 430 to a second position. In any example of the disclosure, the predetermined magnitude of the force may correspond to a maximum desired force, for example the maximum force which may be safely exerted on the barrier.

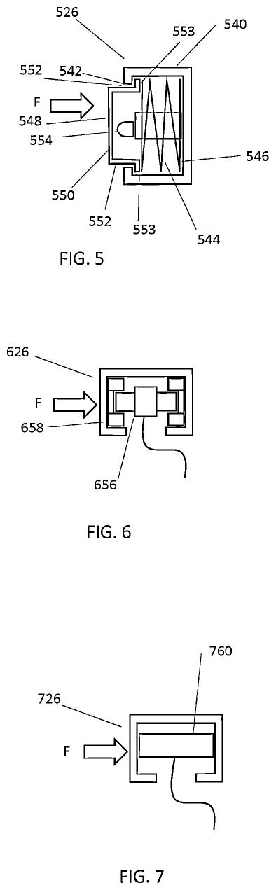

FIG. 5 shows a schematic cross sectional illustration of another example system according to the disclosure. The sensor of this example may again comprise a sensor, for example a switch, for detecting when a maximum allowable load on the barrier is exceeded. In the example shown, a rail 526 of a barrier (not shown) is made in two parts. The rail 526 comprises a housing 540 which is hollow and may be rectangular in cross section. The housing 540 has an opening 542 in one face thereof. A resilient means such as a spring 544 is mounted to an inner face 546 of the housing 540 so as to extend from the inner face 546 towards the opening 542. A movable part 548 extends out from the opening 542 and is configured to be pushed in towards the inside of the housing 540 when a force is applied to it. The movable part 548 comprises a contact face 550 and side walls 552 extending away from the contact face 550 to form a U-shaped or Omega-shaped body. In the example shown, flanges 553 extend outwardly from each side wall 552 such that the flanges 553 extend beyond the opening 542 and overlap with the housing 540 to hold the movable part 548 in the housing 540.

The spring 544 is mounted between the inner face 546 of the housing 540 and the flanges 553 so as to bias the movable part 548 away from the inner face 546. A switch 554 is mounted in the housing such that when the movable part 548 is in a first position, biased away from the inner face 546, the movable part 548 does not contact the switch 554 and the switch 554 is in a first position.

When a horizontal force F of a predetermined amount or greater is applied to the movable part 548 (for example, due to a person leaning on the rail 526, for example against the contact face 550), the movable part 548 will compress the spring 544 such that the movable part 548 activates the switch 554, moving the switch 554 to a second position.

In the examples described above with reference to FIGS. 4A and 4B and 5 for example, the safety signal may be produced when the switch 430, 554 is moved to or is in the second position. It will be appreciated that although a mechanical switch is described in the examples above, the safety signal could instead be produced for example by a signal produced by other types of switch such as an electrical contact which is brought into contact with the rail or moveable part when the spring is compressed.

Still further examples of safety systems according to the disclosure are shown in FIGS. 6 and 7. In these and other examples, the system may be configured to measure a load or force exerted on the barrier and to produce a safety signal when a detected load on the barrier is above a predetermined threshold or above a maximum allowable value.

FIG. 6 shows a cross section through a rail 626 of a barrier (not shown). In the example shown, a sensor such as a load cell 656 is mounted inside the rail 626 on supports 658. The load cell 656 is configured to measure a load F applied to the rail 626 and to produce a safety signal when the detected load is above a predetermined threshold or above a maximum allowable value.

FIG. 7 shows another cross section through a rail 726 of a barrier (not shown). In the example shown, a piezoelectric sensor 760 is mounted inside the rail 726. The piezoelectric sensor 760 is again configured to measure a load F applied to the rail 726 and to produce a safety signal when the detected load is above a predetermined threshold or above a maximum allowable value.

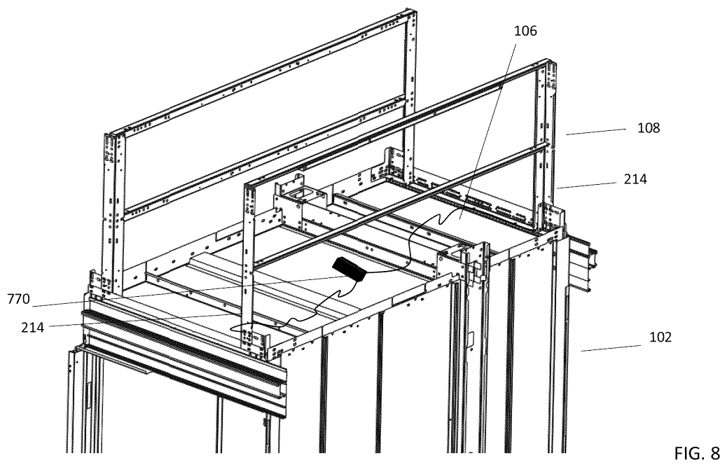

A still further example of a safety system according to the disclosure is shown in FIG. 8. In this and other examples, a safety signal may be generated when a sensor detects that a person or other component is in contact with the barrier. At least in some examples, the sensor may include a device for measuring and monitoring the resistance of the barrier. In the example shown, the sensor may be any suitable device for measuring resistance such as a multimeter or ohmmeter for example. The device 770 may for example be mounted to the external upper surface 106 of an elevator car 102 or could be mounted to the barrier 108.

In some examples, the barrier 108 may be electrically insulated from the elevator car 102 in order to improve the resistance measurement for the barrier 108. For example, electrical insulation may be provided between the external upper surface 106 of the elevator car 102 and each support member 214 of the barrier 108 which is fixed to the external upper surface 106 of the elevator car 102.

In the example shown, the device 770 is wired or otherwise connected between the first and second support members so as to measure a resistance across the barrier 108 from the first support member 214 to the second support member 214. A person (for example maintenance personnel) contacting the barrier 108 would cause a change in the resistance measured, resulting in a safety signal being generated as described above.

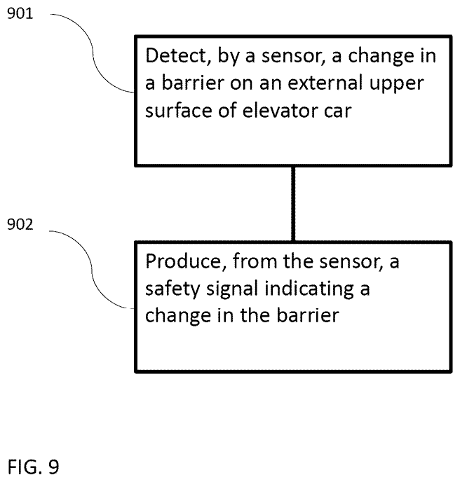

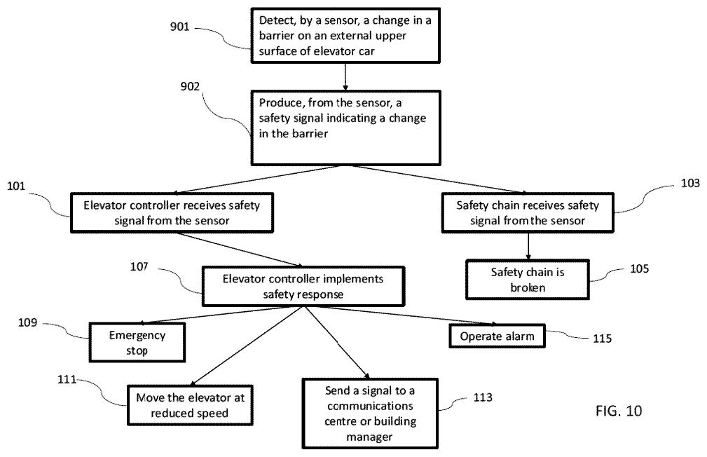

FIGS. 9 and 10 are flow charts showing methods of operating an elevator safety system, such as by detecting a change in a barrier in an elevator system, according to various examples of the present disclosure.

In FIG. 9 at step 901 a change in the barrier is detected by a sensor. The sensor then produces a safety signal at step 902, which indicates a change in the barrier. As described above, the sensor could be any suitable device which responds to an external stimulus to determine that a change has occurred in the barrier. In any example of the disclosure the detected change in the barrier may be at least one of: a movement of at least a part of the barrier; a change in a force applied to the barrier; and a change in resistance of the barrier. As described above, the sensor may comprise any suitable means including but not limited to: a light sensor; a switch; a load cell; a piezoelectric sensor; or a device for measuring resistance across the barrier.

The safety signal may include any amount of information about the change in the barrier. For example, it could be a binary signal simply indicating that a change has occurred or that a measured value is beyond a predetermined threshold. Alternatively, it could include further information such as the location and status of the elevator.

FIG. 10 shows another optional additional step to the method shown in FIG. 9. In these examples, the safety signal is sent from the sensor to the elevator controller (step 101) and/or the safety chain (step 103). If the safety signal is sent to the safety chain, the safety response is to break the safety chain (step 105). This can cause an emergency stop of the elevator car 102.

In some potentially overlapping examples, the safety signal can be sent to the elevator controller at step 101. The elevator controller then implements a safety response at step 107. The safety response can include any of the following actions, alone or in combination with one another: emergency stop 109, moving the elevator car at a reduced speed 111; sending a signal to a communications centre or building manager 113; and/or operating an alarm 115. It will be understood that the alarm could be one or more of at least an auditory alarm or a visual alarm.

It will be appreciated by those skilled in the art that the disclosure has been illustrated by describing one or more examples thereof, but is not limited to these examples; many variations and modifications are possible, within the scope of the accompanying claims. For example, rather than providing only one sensor, it would be possible to provide any number and any combination of the types of sensors described above in an elevator safety system according to the disclosure. By providing more than one sensor, the safety of an elevator system could be further improved as a change in a barrier could still be detected even in the event of a failure of one of the sensors.

What is claimed is:

1. An elevator safety system comprising:
a barrier (108) for installation on an external upper surface (106) of an elevator car (102); and
a sensor,
wherein the sensor is configured to detect a change in the barrier,
wherein the system is configured to produce a safety signal when a change in the barrier is detected by the sensor.

2. An elevator safety system as claimed in claim 1, wherein the sensor is configured to detect a movement of at least part (316; 426; 548) of the barrier (108).

3. An elevator safety system as claimed in claim 2, wherein the sensor comprises a light beam emitter (322) and a light beam receiver (326).

4. An elevator safety system as claimed in claim 3, wherein the sensor is configured such that light emitted from the light beam emitter (322) is not received by the light beam receiver (326) when the at least part (316) of the barrier (108) is in a first position but is received by the light beam receiver when the at least part of the barrier has moved to a second position, and
wherein the safety signal is produced when the light is received by the light beam receiver.

5. An elevator safety system as claimed in claim 2, wherein the sensor comprises a switch (430; 554) configured to switch from a first state to a second state when the at least part (426; 548) of the barrier (108) has moved from a first position to a second position.

6. An elevator safety system as claimed in claim 5, wherein the at least part (426; 548) of the barrier (108) is movable relative to another part (214; 540) of the barrier,
wherein the switch (430; 554) is mounted to the other part of the barrier and is configured to switch from the first state to the second state when the at least part of the barrier is moved into contact with the switch.

7. An elevator safety system as claimed in claim 6, wherein the at least part (426; 548) of the barrier (108) is resiliently biased away from the other part (214; 540) of the barrier.

8. An elevator safety system as claimed in claim 1, wherein the sensor is configured to detect a change in the load applied to at least part (626; 726) of the barrier (108).

9. An elevator safety system as claimed in claim 8, wherein the sensor comprises a load cell (656) mounted to the at least part (626) of the barrier (108); and/or
wherein the sensor comprises a piezoelectric sensor (760) mounted to the at least part (726) of the barrier (108).

10. An elevator safety system as claimed in claim 1, wherein the sensor is configured to detect a change in resistance in at least part of the barrier (108).

11. An elevator safety system as claimed in claim 2, wherein the at least part (426; 548; 626; 726) of the barrier (108) comprises a rail configured to be spaced from the external upper surface (106) of the elevator car (102) when installed thereon.

12. An elevator system (100) comprising:
a hoistway (104);
an elevator car (102); and
an elevator safety system as claimed in claim 1.

13. An elevator system (100) as claimed in claim 12, wherein the elevator system further comprises an elevator controller, configured to receive the safety signal from the sensor;
wherein, upon receiving the safety signal from the sensor, the elevator controller is configured to implement a safety response.

14. The elevator system (100) as claimed in claim 13, wherein the safety response comprises an emergency stop; and/or
wherein the safety response comprises moving the elevator car (102) at a reduced speed; and/or
wherein the safety response comprises sending a signal to a communications centre or a building manager; and/or
wherein the safety response comprises operating an alarm; and/or
wherein the elevator system further comprises a safety chain configured to receive the safety signal from the sensor,
wherein, upon receiving the safety signal from the sensor, the safety chain is broken.

15. A method of operating an elevator safety system comprising:
detecting, by at least one sensor, a change in a barrier (108) of the elevator safety system; and
producing, from the at least one sensor, a safety signal indicating the change.
